(19) United States
(12) Patent Application Publication
(10) Pub. No.: US 2023/0385961 A1
(43) Pub. Date: Nov. 30, 2023

(54) SYSTEM OF UNDERGROUND UTILITY INFRASTRUCTURE PLANNING

(71) Applicant: 4M Analytics Ltd, Tel-Aviv (IL)

(72) Inventors: Itzik Malka, Golan Heights (IL); Yoav Cohen, Hogla (IL); Nir Cohen, Kochav Yair (IL); Dror Steinmetz, Tel-Aviv (IL); Ayal Green, Ramat-Gan (IL); Harel Dan, Kfar Ruppin (IL)

(21) Appl. No.: 17/828,210

(22) Filed: May 31, 2022

(51) Int. Cl. G06Q 50/08

(52) U.S. Cl. CPC G06Q 50/08

(57) ABSTRACT

There is provided a system of displaying a degree of underground utility infrastructure complexity in a subregion of a terrain, the system comprising a processing circuitry, the processing circuitry being configured to display, on a display device, two or more subregions of the terrain, the displaying being informative of the degree of underground utility infrastructure complexity of the respective subregion, the degree of underground utility infrastructure complexity of the subregion being assigned based one, at least, number, types, length, width, depth, and/or intersections of underground utilities in the respective subregion.

### TECHNICAL FIELD

The presently disclosed subject matter relates to underground mapping, and in particular to implementation of systems of assisting planning of underground utility infrastructure projects.

### BACKGROUND

Problems of planning underground utility infrastructure projects (and avoiding disruption of existing underground utility infrastructure) have been recognized in the conventional art and various techniques have been developed to provide solutions.

### GENERAL DESCRIPTION

According to one aspect of the presently disclosed subject matter there is provided a processor-based method of determining a degree of underground utility infrastructure complexity in a subregion of a terrain, the method comprising:
a) obtaining data indicative of:
   a. locations of one or more underground utilities in the terrain; and
   b. respective utility types of the one or more underground utilities; and
b) assigning the degree of underground utility infrastructure complexity of the subregion from, at least, one or more of a group comprising:
   i) a number of underground utilities in the respective subregion,
   ii) one or more types of underground utilities in the respective subregion,
   iii) a length of one or more underground utilities in the respective subregion,
   iv) a width of one or more underground utilities in the respective subregion,
   v) a depth of one or more underground utilities in the respective subregion, and
   vi) a number of intersections of underground utilities in the respective subregion;
   wherein i)-vi) are derivative of the obtained data.

In addition to the above features, the method according to this aspect of the presently disclosed subject matter can comprise one or more of features (i) to (iii) listed below, in any desired combination or permutation which is technically possible:
(i) further comprising:
   repeating b) for one or more additional iterations;
(ii) further comprising:
   storing the assigned degree of utility infrastructure complexity to a storage medium; and
(iii) the respective utility types of the one or more underground utilities comprise one or more of a group comprising:
   a) electric power lines;
   b) natural gas pipes;
   c) water pipes;
   d) wastewater transport infrastructure; and
   e) optical or copper communication lines.

According to another aspect of the presently disclosed subject matter there is provided a digital map product comprising a computer readable non-transitory storage medium containing first data informative of, at least, a degree of underground utility infrastructure complexity in one or more subregions of a terrain, the first data being derivative of a processor-based method comprising:
a) obtaining data indicative of:
   i) locations of one or more underground utilities in the terrain; and
   ii) respective utility types of the one or more underground utilities; and
b) assigning the degree of underground utility infrastructure complexity of the subregion from, at least, one or more of a group comprising:
   i) a number of underground utilities in the respective subregion,
   ii) one or more types of underground utilities in the respective subregion,
   iii) a length of one or more underground utilities in the respective subregion,
   iv) a width of one or more underground utilities in the respective subregion,
   v) a depth of one or more underground utilities in the respective subregion, and
   vi) a number of intersections of underground utilities in the respective subregion;
   wherein i)-vi) are derivative of the obtained data.

This aspect of the disclosed subject matter can further optionally comprise one or more of features (i) to (iii) listed above with respect to the method, mutatis mutandis, in any desired combination or permutation which is technically possible.

According to another aspect of the presently disclosed subject matter there is provided a system of displaying a degree of underground utility infrastructure complexity in a subregion of a terrain, the system comprising a processing circuitry, the processing circuitry comprising a processor and memory, the processing circuitry being configured to:
a) display, on a display device, two or more subregions of the terrain, the displaying being informative of the degree of underground utility infrastructure complexity of the respective subregion.
   wherein the degree of underground utility infrastructure complexity is assigned to a subregion in accordance with at least, one or more of a group comprising:
      i) a number of underground utilities in the respective subregion,
      ii) one or more types of underground utilities in the respective subregion,
      iii) a length of one or more underground utilities in the respective subregion,
      iv) a width of one or more underground utilities in the respective subregion,
      v) a depth of one or more underground utilities in the respective subregion, and
      vi) a number of intersections of underground utilities in the respective subregion.

In addition to the above features, the system according to this aspect of the presently disclosed subject matter can comprise one or more of features (i) to (ii) listed below, in any desired combination or permutation which is technically possible:
(i) the displaying of each subregion of the two or more subregions is in a display color that is derivative of a first display color continuum, wherein the display color continuum associates a degree of underground utility infrastructure complexity with a display color; and
(ii) the processing circuitry is further configured to:

responsive to a user behavior, display a map informative of locations of one or more underground utilities of one or more of the subregions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to understand the invention and to see how it can be carried out in practice, embodiments will be described, by way of non-limiting examples, with reference to the accompanying drawings, in which:

FIG. 1 illustrates a block diagram of an example utility project planning system, in accordance with some embodiments of the presently disclosed subject matter;

FIG. 2 illustrates an example overhead map of a terrain area, with data informative of one or more locations of subregions including subsurface utility infrastructures, in accordance with some embodiments of the presently disclosed subject matter;

FIG. 3 illustrates a flow diagram of an example method assigning a degree of underground utility infrastructure complexity to a subregion of a terrain area, in accordance with some embodiments of the presently disclosed subject matter;

FIGS. 4A and 4B illustrate examples of map display utilizing underground utility infrastructure complexity, in accordance with some embodiments of the presently disclosed subject matter; and

FIG. 5 illustrates a flow diagram of an example method utilizing a utility project planning system, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “determining”, “calculating”, “receiving”, “providing”, “obtaining”, “assigning”, “displaying” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

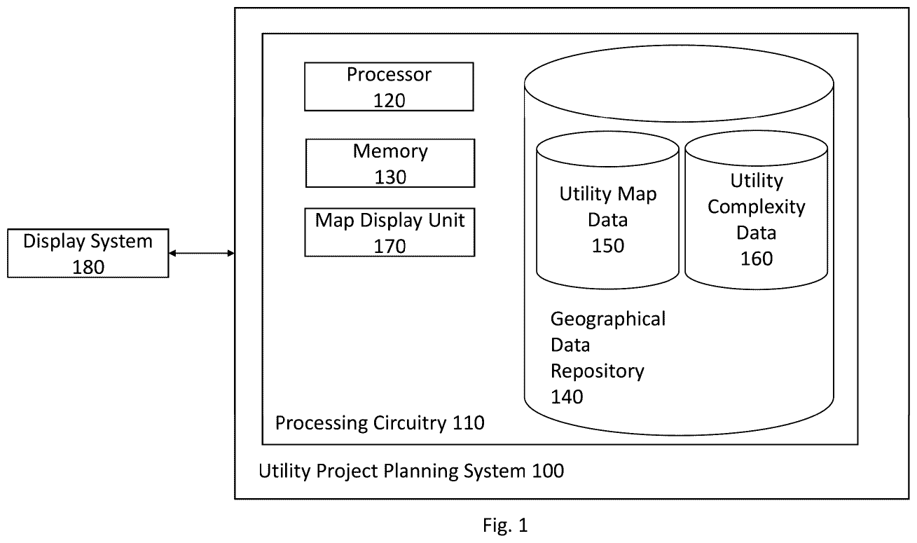

Attention is now directed to FIG. 1, which illustrates a block diagram of an example utility project planning system, in accordance with some embodiments of the presently disclosed subject matter.

Utility project planning system 100 can include a processing circuitry 110, which in turn can include a processor 120 and memory 130.

Processor 120 can be a suitable hardware-based electronic device with data processing capabilities, such as, for example, a general purpose processor, digital signal processor (DSP), a specialized Application Specific Integrated Circuit (ASIC), one or more cores in a multicore processor etc. Processor 120 can also consist, for example, of multiple processors, multiple ASICs, virtual processors, combinations thereof etc.

Memory 130 can be, for example, a suitable kind of volatile and/or non-volatile storage, and can include, for example, a single physical memory component or a plurality of physical memory components. Memory 130 can also include virtual memory. Memory 130 can be configured to, for example, store various data used in computation.

Processing circuitry 110 can be configured to execute several functional modules in accordance with computer-readable instructions implemented on a non-transitory computer-readable storage medium. Such functional modules are referred to hereinafter as comprised in the processing circuitry. These modules can include, for example, geographical data repository 140, and map display unit 170.

Geographical data repository 140 can be any kind of suitable data storage medium, and can include, for example, utility map data 150 and utility complexity data 160.

Utility map data 150 can contain, for example, a vector map or other suitable structure describing specific locations of all the utilities in a particular geographical region.

Utility complexity data 160 can contain data identifying subregions of the geographical region (e.g. the data can describe a grid of square subregions, where each square subregion is of a particular size eg. 25 meters by 25 meters).

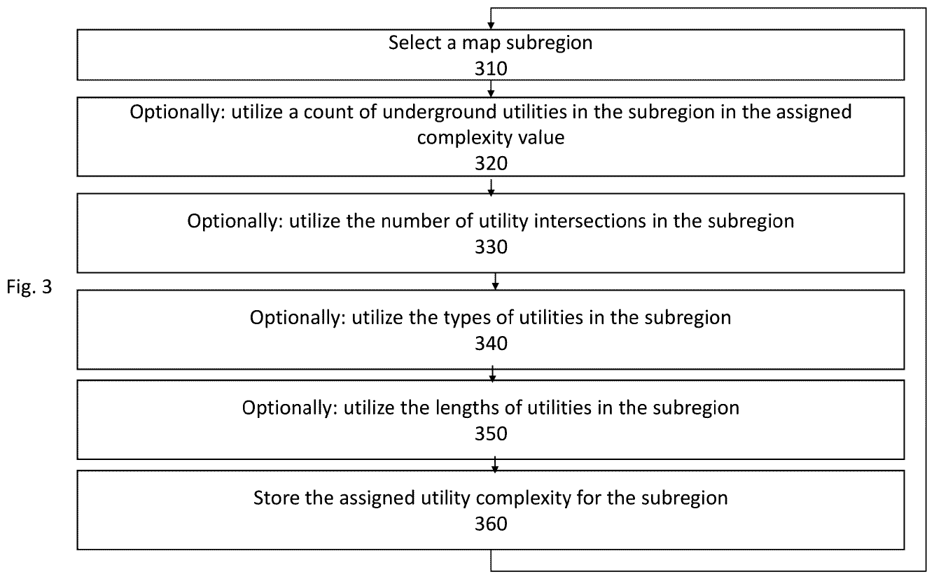

For each of the subregions, utility complexity data 160 can contain an associated value indicative of the degree of complexity of the utility infrastructure in the subregion. In some examples, planner awareness of the degree of complexity of utility infrastructure can affect excavation, construction plans, damage potential etc. of a utility project. A degree of complexity of utility infrastructure in a subregion can be determined, for example, using the method described below with reference to FIG. 3.

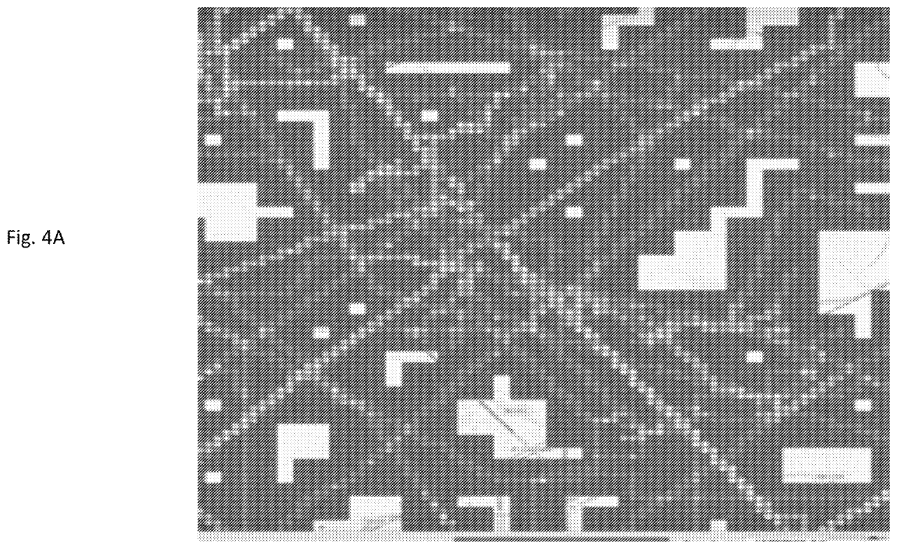

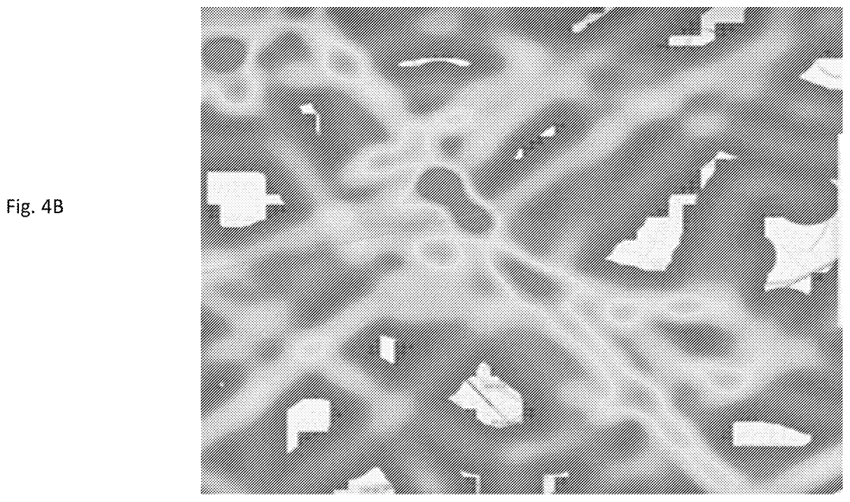

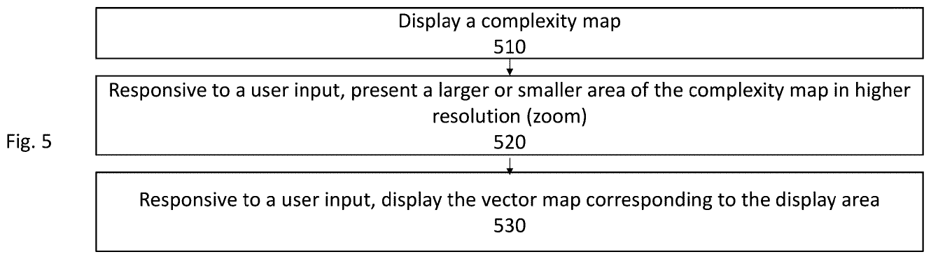

Map display unit 170 can implement a map application that displays data on (and/or receives user input from) display system 180 (which can be located locally, or can be located remotely and connected to utility project planning system 100 via a network and e.g. a web browser). By way of non-limiting example, map display unit 170 can display a “underground utility complexity map”—possibly in conjunction with vector maps, as described below with reference to FIG. 4. Engineers and planners can utilize the underground utility complexity map and vector map in early stages of underground utility project planning, as described below with reference to FIG. 5.

It is noted that while the present disclosure addresses “underground utilities”, “underground utility infrastructure”, “subsurface utilities” etc. the mapping systems, methods, products etc. are applicable to on-ground and above-ground utility infrastructure (such as electric cables or communication cables that are on electric poles or telephone poles). Accordingly, all references herein to underground utilities and similar terms are to be understood as non-exclusive, and to include such on-ground and above-ground utilities.

It is noted that the teachings of the presently disclosed subject matter are not bound by the system described with reference to FIG. 1. Equivalent and/or modified functionality can be consolidated or divided in another manner and can be implemented in any appropriate combination of software with firmware and/or hardware and executed on a suitable device. The utility project planning system 100 can be a standalone entity, or integrated, fully or partly, with other entities.

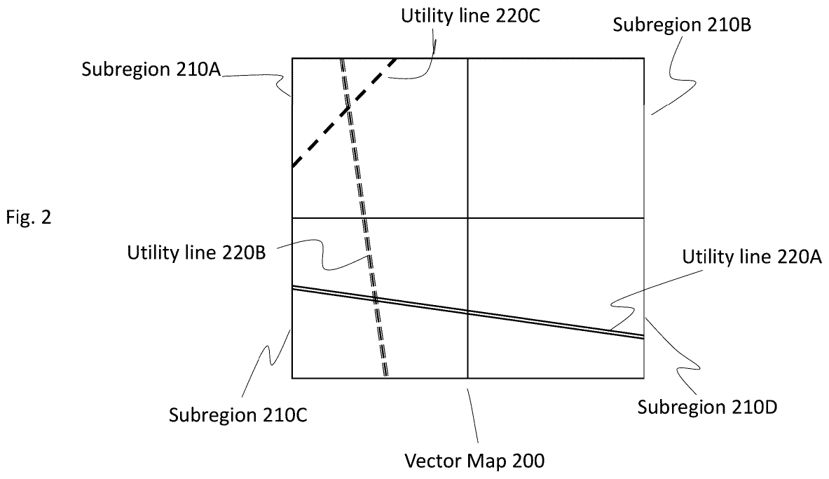

Attention is now directed to FIG. 2, which illustrates an example of an underground utilities vector map, in accordance with some embodiments of the presently disclosed subject matter.

In FIG. 2, vector map 200 is divided into subregions 210A 210B 210C 210D. Each of 210A 210B 210C 210D can represent a geographic subregion (e.g. a rectangle or polygon) with particular dimensions (e.g. rectangle of 25 meters by 25 meters)

It will be understood that vector map 200 is shown to include four subregions for purposes of clarity, and that vector map 200 can include a larger number of subregions.

FIG. 2 depicts several utility lines 220A 220B 220C and their locations/lengths in the subregions. Each of utility lines 220A 220B 220C can be, for example, a utility line type such as an electric cable, natural gas pipe, energy/petrol pipes, water pipe, wastewater transport channel, copper or fiberoptic communication cable, etc. Vector map 200 can include—for any utility line— data indicative of a utility line locations, lengths, and types.

Vector map 200 can include—for any utility line—data indicative of the depth at which the line is buried.

Vector map 200 can include—for any utility line—data indicative of the width of the line.

Vector map 200 can include—for any utility lines—data indicative of the intersections of the utility lines. FIG. 2 illustrates utility line intersections e.g. utility line 220C crosses the path of utility line 220B in subregion 210A.

It will be understood that vector map 200 includes three utility lines for purposes of clarity, and that vector map 200 can include a larger number of utility lines.

Attention is now directed to FIG. 3, which illustrates a flow diagram of an example method of assigning a utility complexity value to a subregion, in accordance with some embodiments of the presently disclosed subject matter.

The processor-based method described in FIG. 3 can be executed by an offline process, and the result of the method can then, for example, be stored in, for example, utility complexity data 160.

The processor can begin by selecting 310 a subregion of a vector map (e.g. subregion 210A of vector map 200).

The count of utilities in a subregion can be indicative of, for example, the complexity or difficulty of executing an underground utility project therein. Thus, the processor can optionally utilize 320 a count of underground utilities in the subregion in the assigned degree of complexity.

The number of utility intersections in a subregion can be indicative of, for example, the complexity or difficulty of executing an underground utility project therein. Thus, the processor can optionally utilize 330 the number of utility intersections in the subregion in the assigned degree of complexity.

The types of utilities in a subregion can be indicative of, for example, the complexity or difficulty of executing an underground utility project therein. Thus, the processor can optionally utilize 340 the types of utilities in the subregion in the assigned degree of complexity.

The lengths or widths of utilities in a subregion can be indicative of, for example, the complexity or difficulty of executing an underground utility project therein. Thus, the processor can optionally utilize 350 the lengths or widths of utilities in the subregion in the assigned degree of complexity.

The processor can store 360 the assigned degree of utility complexity (e.g. to a storage medium) in a manner that, for example, associates it with the subregion, and the return to select 310 another subregion.

By way of non-limiting example: the processor can determine a value between 0 and 15 for a particular subregion based on a sum of:
a value between 0 and 3 assigned based on the count of utilities in the subregion
a value between 0 and 3 based on the count of intersections of utilities in the subregion
a value between 0 and 3 based on the total length of utilities in the subregion
a value of 5 if there is a natural gas line in the subregion

In this manner, the presently described system can, in some embodiments and among other advantages, provide discrete values indicative of utility infrastructure complexity in a subregion, thus solving technical problems of utility project planning.

It is noted that the teachings of the presently disclosed subject matter are not bound by the flow diagram illustrated in FIG. 3, and that in some cases the illustrated operations may occur concurrently or out of the illustrated order (for example: operations 330 and 340 can be reversed). It is also noted that whilst the flow chart is described with reference to elements of the system of FIG. 1, this is by no means binding, and the operations can be performed by elements other than those described herein.

Attention is now directed to FIGS. 4A-4B, which illustrate an example geographic area displayed in several different map styles, in accordance with some embodiments of the presently disclosed subject matter.

FIG. 4A illustrates an example utility complexity map, wherein each geographic subregion of a particular size (e.g. 25 meters by 25 meters) is represented by a particular color, and the color in turn represents a particular assigned utility complexity value.

FIG. 4B illustrates a corresponding example utility complexity map, wherein a smoothing technique has been applied to the colors of the geographic subregions. The smoothed map effectively depicts relative complexity of underground utility infrastructure in clusters of subregions. A smoothing function, in this context, can include a visual values function that is continuous without breaks or abrupt bends.

It is noted that there are other manners of displaying utility complexity map data. For example, a representing the utility complexity value can be displayed on a vector map in response to a mouse-over event.

Attention is now directed to FIG. 5, which illustrates a flow diagram of an example scenario of a user utilizing a utility project planning system, in accordance with some embodiments of the presently disclosed subject matter.

Processing circuitry 110 (for example: map display unit 170) can display (510) a utility complexity map (for example as shown in FIG. 4B) on display system 180.

Responsive to, for example, a first user input (such as a mouse click or other user interface interaction), processing circuitry 110 (for example: map display unit 170) can present a larger or smaller area of the utility complexity map with a lower or higher level-of-detail (i.e. “zoom” functionality). In some embodiments, when processing circuitry 110 (for example: map display unit 170) displays a larger area (e.g. in a fixed size display), the geographic area represented by one pixel is accordingly smaller. Similarly, in some embodiments, when processing circuitry 110 (for example: map display unit 170) displays a comparatively small area (e.g. in a fixed size display), the geographic area represented by one pixel is accordingly larger. In some embodiments, map display unit 170 can utilize a mapping application programmer's interface (API) such as those provided by Microsoft or Google in order to provide scalable mapping service to a display system 180 that is located remotely and operably connected via a network.

Responsive to, for example, a second user input (such as a mouse click or other user interface interaction), processing circuitry 110 (for example: map display unit 170) can then display e.g. a vector map of the underground utilities (for example: as shown in FIG. 2) in the geographic display area previously displayed in the utility complexity map.

In this manner, the presently described system can, in some embodiments and among other advantages, constitute an effective tool of underground utility project planning.

It is noted that the teachings of the presently disclosed subject matter are not bound by the flow diagram illustrated in FIG. 5, and that in some cases the illustrated operations may occur concurrently or out of the illustrated order (for example: operations 520 and 530 can be reversed). It is also noted that whilst the flow chart is described with reference to elements of the system of FIG. 1, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A processor-based method of determining a degree of underground utility infrastructure complexity in a subregion of a terrain, the processor-based method comprising:
a) obtaining data indicative of:
i) locations of one or more underground utilities in the terrain; and
ii) respective utility types of the one or more underground utilities; and
b) assigning the degree of underground utility infrastructure complexity of the subregion from, at least, one or more of a group comprising:
i) a number of underground utilities in the respective subregion,
ii) one or more types of underground utilities in the respective subregion,
iii) a length of one or more underground utilities in the respective subregion,
iv) a width of one or more underground utilities in the respective subregion,
v) a depth of one or more underground utilities in the respective subregion, and
vi) a number of intersections of underground utilities in the respective subregion;
wherein i)-vi) are derivative of the obtained data.

2. The processor-based method of claim 1, the method further comprising:
repeating b) for one or more additional iterations.

3. The processor-based method of claim 1, the method further comprising:
storing the assigned degree of utility infrastructure complexity to a storage medium.

4. The processor-based method of claim 1, wherein the respective utility types of the one or more underground utilities comprise one or more of a group comprising:
a) electric power lines;
b) natural gas pipes;
c) water pipes;
d) wastewater transport infrastructure; and
e) optical or copper communication lines.

5. A system of displaying a degree of underground utility infrastructure complexity in a subregion of a terrain, the system comprising a processing circuitry, the processing circuitry comprising a processor and memory, the processing circuitry being configured to:
a) display, on a display device, two or more subregions of the terrain, the displaying being informative of the degree of underground utility infrastructure complexity of the respective subregion.
wherein the degree of underground utility infrastructure complexity is assigned to a subregion in accordance with at least, one or more of a group comprising:
i) a number of underground utilities in the respective subregion,
ii) one or more types of underground utilities in the respective subregion,
iii) a length of one or more underground utilities in the respective subregion,
iv) a width of one or more underground utilities in the respective subregion,
v) a depth of one or more underground utilities in the respective subregion, and
vi) a number of intersections of underground utilities in the respective subregion.

6. The system of claim 5, wherein the displaying of each subregion of the two or more subregions is in a display color that is derivative of a first display color continuum,
wherein the display color continuum associates a degree of underground utility infrastructure complexity with a display color.

7. The system of claim 5, wherein the processing circuitry is further configured to:
responsive to a user behavior, display a map informative of locations of one or more underground utilities of one or more of the subregions.

8. A digital map product comprising a computer readable non-transitory storage medium containing first data informative of, at least, a degree of underground utility infrastructure complexity in one or more subregions of a terrain,
the first data being derivative of a processor-based method comprising:
a) obtaining data indicative of:
i) locations of one or more underground utilities in the terrain; and
ii) respective utility types of the one or more underground utilities; and
b) assigning the degree of underground utility infrastructure complexity of the subregion from, at least, one or more of a group comprising:
i) a number of underground utilities in the respective subregion,
ii) one or more types of underground utilities in the respective subregion,
iii) a length of one or more underground utilities in the respective subregion,
iv) a width of one or more underground utilities in the respective subregion,
v) a depth of one or more underground utilities in the respective subregion, and
vi) a number of intersections of underground utilities in the respective subregion;
wherein i)-vi) are derivative of the obtained data.
